(19) United States
(12) Patent Application Publication
(10) Pub. No.: US 2013/0314307 A1
(43) Pub. Date: Nov. 28, 2013

(54) DRIVING SYSTEM AND METHOD FOR DOT-MATRIX LIGHT-EMITTING DIODE DISPLAY DEVICE

(71) Applicants: Sheng-Ming LIN, Hsinchu City (TW); Ken-Tang WU, Hsinchu City (TW); Jen-Chou HSU, Hsinchu City (TW)

(72) Inventors: Sheng-Ming LIN, Hsinchu City (TW); Ken-Tang WU, Hsinchu City (TW); Jen-Chou HSU, Hsinchu City (TW)

(73) Assignee: MACROBLOCK, INC., Hsinchu City (TW)

(21) Appl. No.: 13/595,871

(22) Filed: Aug. 27, 2012

(30) Foreign Application Priority Data
May 23, 2012 (TW) 101118393

(51) Int. Cl. G09G 3/32

(52) U.S. Cl. 345/82

(57) ABSTRACT

A driving system and a method for a dot-matrix light-emitting diode display device. The driving system comprises a controller, a scan line driver, and a signal line driver. The controller provides a scan line control signal and a signal line control signal. The scan line driver generates a scan line driving signal in response to the scan line control signal. The scan line driving signal is divided into an ON period and a OFF period. The signal line driver generates a signal line driving signal in response to the signal line control signal. The signal line driver generates a discharging control signal or a charging control signal during the OFF period so that the signal line driver and the plurality of signal lines form the discharging or charging paths. Therefore, the parasitic capacitors on the scan lines are discharged or the parasitic capacitors on the signal lines are charged.

### CROSS-REFERENCE TO RELATED APPLICATIONS

This non-provisional application claims priority under 35 U.S.C. §119(a) on Patent Application No(s). 101118393 filed in Taiwan, R.O.C. on May 23, 2012, the entire contents of which are hereby incorporated by reference.

### BACKGROUND

1. Technical Field

The disclosure relates to a driving system and method for a dot-matrix light-emitting diode (LED) display device, more particularly to a driving system and method for a dot-matrix light-emitting diode (LED) display device which is capable of eliminating anomalous bright points.

2. Related Art

FIG. 1 is a system architecture diagram of a dot-matrix LED display device according to the prior art. The dot-matrix LED display device has a display panel 10 which comprises a plurality of LEDs. The LEDs D₀₀-D₃₃ are arranged in a matrix. The lateral line of LEDs is generally defined as the scan line, for example WL₁, WL₂, WL₃ . . . and WLₙ₋₁, as shown in FIG. 1. The vertical line of LEDs is defined as the signal line, for example BL₀, BL₁, BL₂, BL₃ . . . and BLₘ₋₁, as shown in FIG. 1. FIG. 2 shows a detailed circuit diagram for the dot-matrix LED display device according to the prior art. As shown in FIG. 2, the anode of each LED is connected to a scan line, and the cathode of each LED is connected to a signal line. For easy illustration, the matrix in FIG. 2 is a 4×4 matrix.

The display device further comprises a controller 11, a scan line driver 12, and a signal line driver 13. The controller 11 provides the scan line control signal to the scan line driver 12 and provides the signal line control signal to the signal line driver 13. The scan line driver 12 provides the driving voltage to the scan lines WL₀, WL₁, WL₂, WL₃ . . . WLₙ₋₁ in response to the scan line control signal. The driving voltage is periodically provided to each scan line WL₀, WL₁, WL₂, WL₃ . . . WLₙ₋₁. At each time only one scan line is provided with the driving voltage. The signal line driver 13 provides the driving current to each signal line BL₀, BL₁, BL₂, BL₃ . . . BLₘ₋₁ in response to the signal line control signal. The driving current is used to drive the LEDs to emit light.

In the detailed circuit shown in FIG. 2, the scan line driver 12 provides the scan line driving signal SK₀, SK₁, SK₂, or SK₃ to control the opening or closing of the switch K₀, K₁, K₂, or K₃ respectively and thus to determine whether to drive the corresponding scan line. One end of the switches K₀, K₁, K₂, and K₃ is connected to the power supply source VBB. The signal line driver 13 provides the signal line driving signal SF₀, SF₁, SF₂, or SF₃ to control the opening or closing of the switch F₀, F₁, F₂, or F₃ respectively. The current sources J₀, J₁, J₂, and J₃ provide the current for driving the LEDs.

Because of the metal wire arrangement, each scan line WL₀, WL₁, WL₂, or WL₃ has the parasitic capacitor CW₀, CW₁, CW₂, or CW₃. Each signal line BL₀, BL₁, BL₂, or BL₃ has the parasitic capacitor CB₀, CB₁, CB₂, or CB₃.

The dot-matrix LED display device according to the prior art may generate anomalous bright points which are also called as ghost. When each lateral line of LEDs is lighted in turn, if the LEDs which should not emit light and are adjacent to the normally lighting LED emits light slightly, this phenomenon is called ghost. If the row of LEDs at the upper side of the normal LEDs does not emit light normally, this is called up-ghost. On the other hand, if the row of LEDs at the lower side of the normal LEDs does not emit light normally, this is called down-ghost.

The following will explain how the up-ghost is formed. When the scan line WL₀ is drove, the switch K₀ is conducted and the parasitic capacitor CW₀ on the scan line WL₀ is charged to the high voltage level approximate to the power supply source VBB. When the scan line is switched to the WL₁ from WL₀, the switch K₀ is not in conduction while switches K₁ and F₂ are in conduction. The LED D₁₂ is lighted. At this time, the voltage of the signal line BL₂ connected to the cathode of the LED D₁₂ changes to the low voltage level approximated to the ground voltage. The forward bias voltage on the LED D₀₂ at this moment is greater than the conduction specified voltage, and thus the LED D₀₂ is in conduction. The electric charge on the parasitic capacitor CW₀ is discharged by the LED D₀₂ and the switch F₂. As a result, the LED D₀₂ cannot emit light normally. Therefore, the up-ghost of the normal LED D₁₂ is formed.

The following will explain how the down-ghost is formed. When the scan line WL₀ is drove and the switches K₀ and F₃ are in conduction, the LED D₀₃ is lighted. At this time, the parasitic capacitor CB₃ on the signal line BL3 has the low voltage level approximate to the ground voltage. When the scan line is switched to WL₁ from WL₀, the switch K₀ is not in conduction while the switch K₁ is in conduction. The scan line WL₁ connected to the anode of the LED D₁₃ has the high voltage level approximate to the power supply source VBB. The forward bias voltage on the LED D₁₃ at the moment is greater than the conduction specified voltage, and thus the LED D₁₃ is in conduction. The parasitic capacitor CB₃ is charged by the LED D₁₃. As a result, the LED D₁₃ cannot emit light normally. The down-ghost of the normal LED D₀₃ is formed.

In the prior art, additional circuits are designed to eliminate the anomalous bright points. FIG. 3 shows an up-ghost eliminating circuit 21 and FIG. 4 shows another up-ghost eliminating circuit 22. The up-ghost eliminating circuit 21 comprises the switches M₀, M₁, M₂, and M₃ connected to the scan lines WL₀, WL₁, WL₂, and WL₃, and a bleeder resistor R. The switches M₀, M₁, M₂, and M₃ are controlled by the control signals SG₀, SG₁, SG₂, and SG₃ outputted from the controller 11. The up-ghost eliminating circuit 22 comprises the diodes MD₀, MD₁, MD₂ and MD₃ connected to the scan lines WL₀, WL₁, WL₂, and WL₃ respectively, the switch SG, and the current source 24. The circuit 21 or 22 provides a discharging path for discharging the electric charge of the parasitic capacitors on the scan lines. In this way, the discharged current goes through the circuit 21 but not through the LED on the display device. Furthermore, the discharged current does not go through the signal lines. The charging circuit for the signal line is designed to overcome the problem of down-ghost.

Therefore, the additional ghost eliminating circuits will add the circuit cost. Furthermore, the resistors used in the ghost eliminating circuit 21 as shown in FIG. 3 will cause the LED to carry a reverse bias voltage which is beyond the specified standard and thus the service life of the LED will be impacted.

### SUMMARY

In one aspect, a driving system for a dot-matrix light-emitting diode (LED) display device is disclosed. The driving system is used to drive a display panel comprising a plurality of LEDs. Each LED is disposed at intersections drive a display panel comprising a plurality of LEDs. The driving system comprises a controller, a scan line driver, and a signal line driver. The controller is used to provide a scan line control signal and a signal line control signal. The scan line driver is used to generate a scan line driving signal to drive the plurality of the scan lines in response to the scan line control signal. The scan line driving signal is divided into an ON period and a OFF period. The signal line driver is used to generate a signal line driving signal in response to the signal line control signal. The signal line driving signal drives the plurality of LEDs to emit light during the ON period. The signal line driver generates a charging or discharging control signal during the OFF period so that the signal line driver and the plurality of signal lines form a plurality of discharging paths through which parasitic capacitors on the plurality of scan lines are discharged or the signal line driver and the plurality of signal lines form a plurality of charging paths through which parasitic capacitors on the plurality of signal lines are charged.

In another aspect, a driving method for a dot-matrix light-emitting diode (LED) display device is disclosed. The driving method is used to drive a display panel which comprises a plurality of LEDs. Each LED is disposed at intersections of a plurality of scan lines and a plurality of signal lines. The driving method comprises providing a scan line control signal and a signal line control signal, generating a scan line driving signal in response to the scan line control signal, generating a signal line driving signal in response to the signal line control signal, and generating a charging or discharging control signal during the OFF period so that the plurality of signal lines form a plurality of discharging paths through which parasitic capacitors on the plurality of scan lines are discharged or the signal line driver and the plurality of signal lines form a plurality of charging paths through which parasitic capacitors on the plurality of signal lines are charged The scan line driving signal is divided into an ON period and a OFF period. The signal line driving signal drives the plurality of LEDs to emit light during the ON period. The plurality of LEDs do not emit light during the OFF period.

### BRIEF DESCRIPTION OF THE DRAWINGS

The present disclosure will become more fully understood from the detailed description given herein below for illustration only, and thus are not limitative of the present disclosure, and wherein:

FIG. 1 is a system architecture diagram of a dot-matrix LED display device according to the prior art;

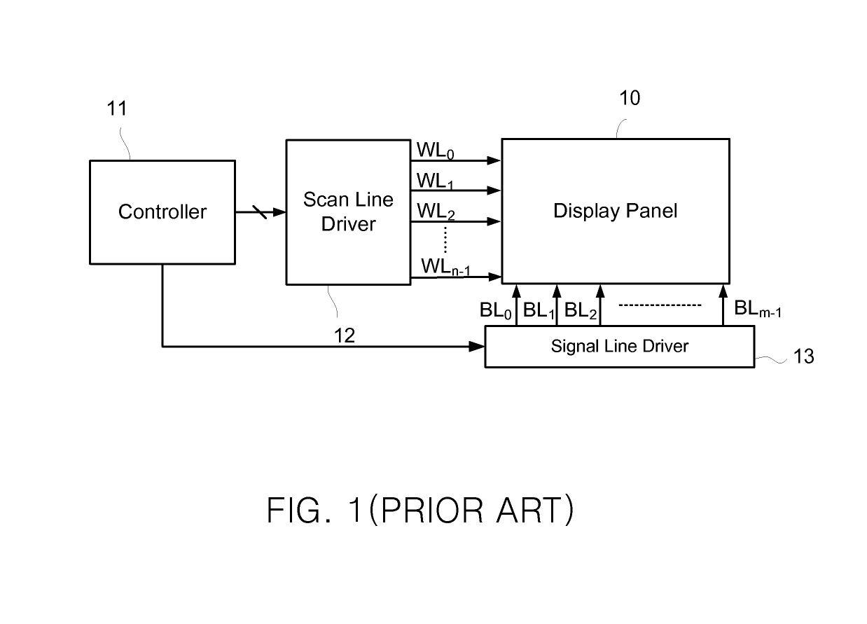

FIG. 2 is a circuit diagram of a dot-matrix LED display device according to the prior art;

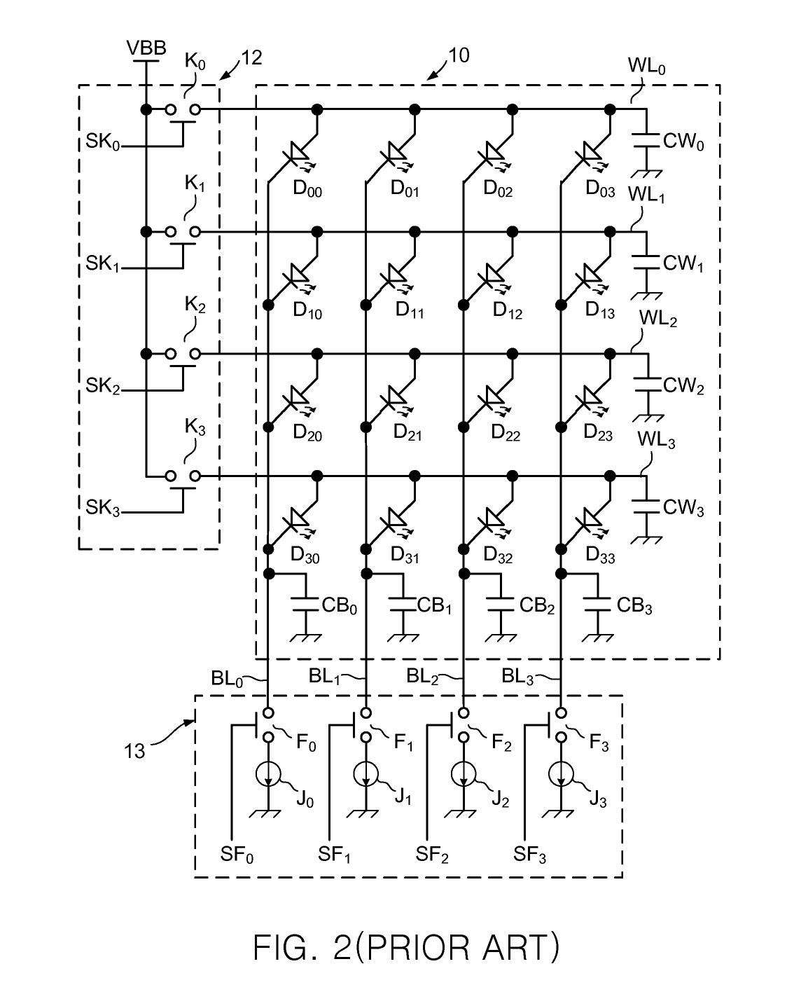

FIG. 3 shows a circuit for eliminating anomalous bright points in the dot-matrix LED display device according to the prior art;

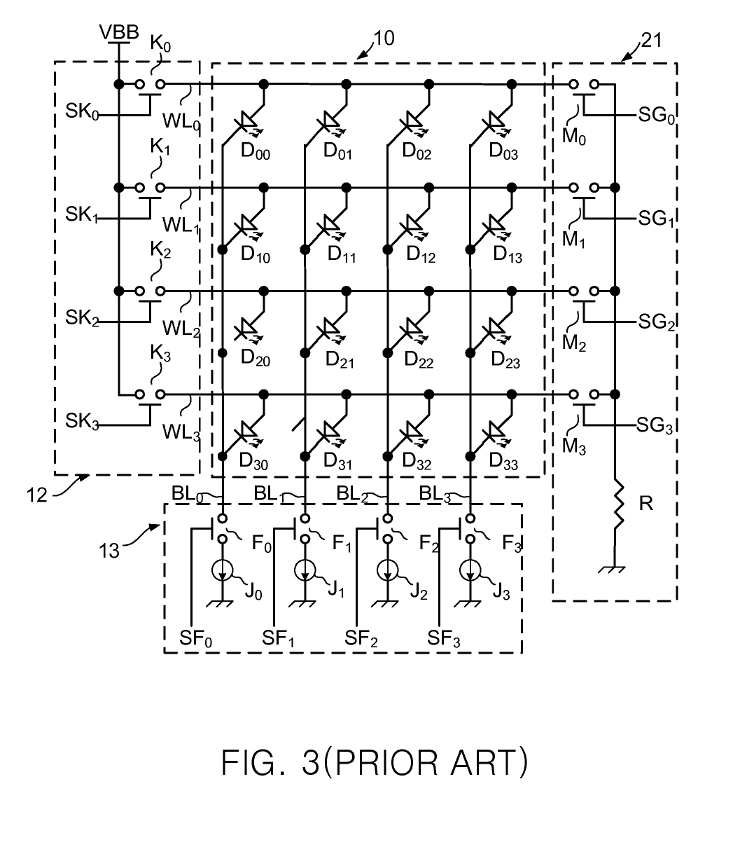

FIG. 4 shows another circuit for eliminating anomalous bright points in the dot-matrix LED display device according to the prior art;

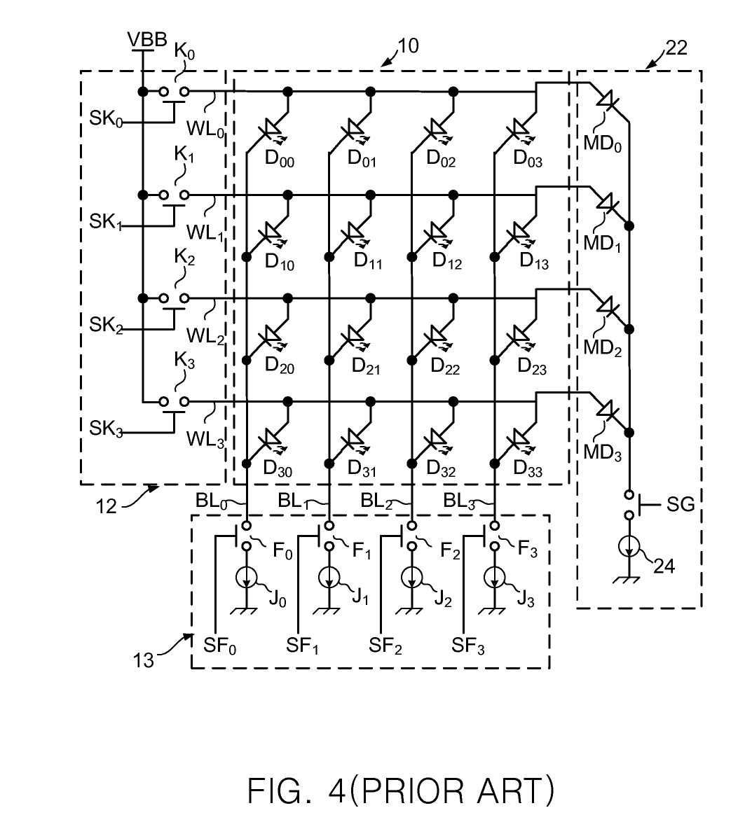

FIG. 5 is a system architecture diagram of a dot-matrix LED display device according to an embodiment of the disclosure;

FIG. 6 shows an embodiment of a circuit diagram for a dot-matrix LED display device;

FIG. 7 shows another embodiment of a circuit diagram for a dot-matrix LED display device; and

FIG. 8 shows a timing diagram of a dot-matrix LED display device according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The detailed characteristics and advantages of the disclosure are described in the following embodiments in details, the techniques of the disclosure can be easily understood and embodied by a person of average skill in the art, and the related objects and advantages of the disclosure can be easily understood by a person of average skill in the art by referring to the contents, the claims and the accompanying drawings disclosed in the specifications.

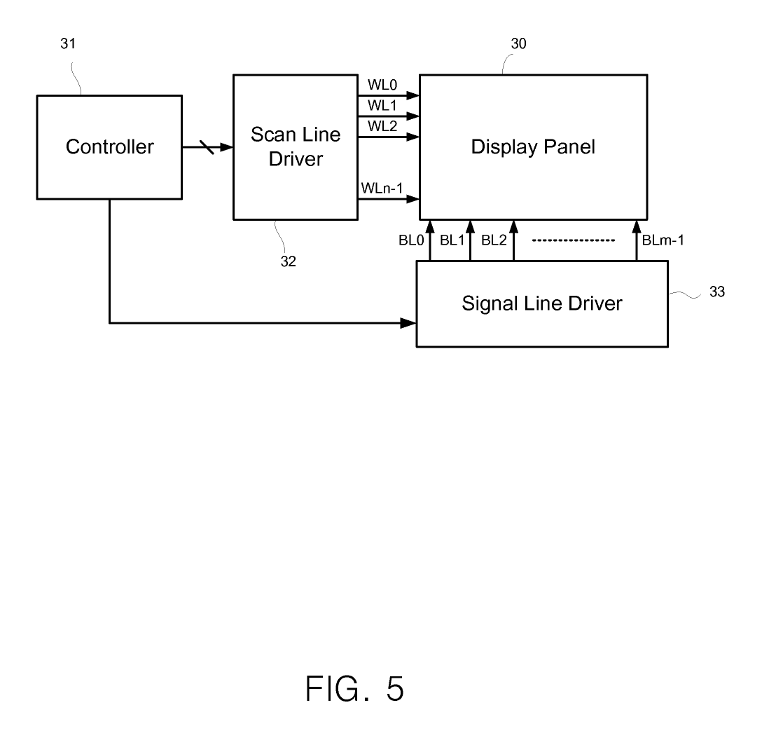

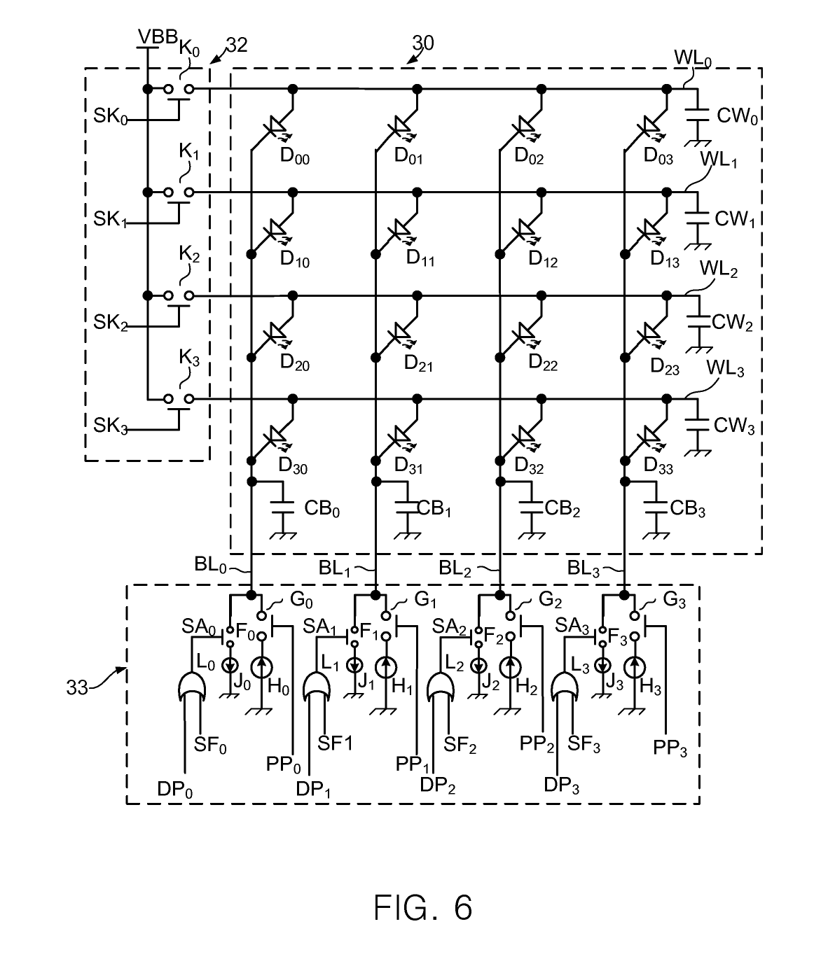

FIG. 5 is a system block diagram of a driving device for a dot-matrix light-emitting diode (LED) display which is capable of eliminating anomalous bright points according to an embodiment of the disclosure. FIG. 6 shows an embodiment of a circuit diagram of the driving device for the dot-matrix LED display.

The dot-matrix LED display comprises a display panel 30 comprising a plurality of LEDs D₀₀-D₃₃, as shown in FIG. 6. The LEDs are arranged in a matrix. More particularly, the LEDs are disposed at intersections of the scan lines WL₀, WL₁, WL₂ . . . WLₙ₋₁ and the signal lines BL₀, BL₁, BL₂ . . . BLₘ₋₁. The anode of each LED is connected to scan lines, and the cathode of each LED is connected to a signal line. For easy illustration, FIG. 6 only shows 16 LEDs, 4 signal lines, and 4 scan lines. Persons skilled in the art would know that this embodiment is not intended to limit the disclosure.

As described in the prior art, because of the metal wire arrangement, each lateral scan line WL₀, WL₁, WL₂, or WL₃ has a parasitic capacitance CW₀, CW₁, CW₂, or CW₃ respectively, and each vertical signal line BL₀, BL₁, BL₂, and BL₃ has parasitic capacitance CB₀, CB₁, CB₂, or CB₃ respectively.

The dot-matrix LED display further comprises a controller 31, a scan line driver 32, and a signal line driver 33. The controller 31 provides a scan line control signal and a signal line control signal.

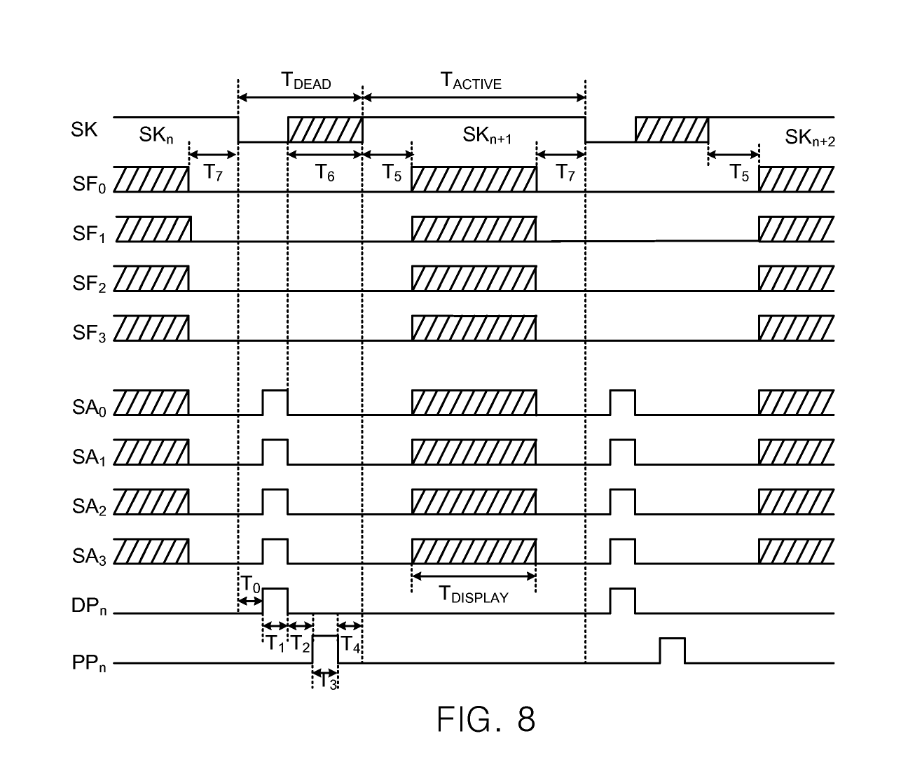

The scan line driver 32 generates the scan line driving signal to the scan lines WL₀, WL₁, WL₂, WL₃ in response to the scan line control signal. The scan line driving signal is periodically provided to each scan line WL₀, WL₁, WL₂, or WL₃. At each time only one scan line is provided with the driving voltage. The scan line driving signal is divided into an ON period and a OFF period. As shown in FIG. 8, the ON period is T_{ACTIVE} and the OFF period is T_{DEAD}.

The signal line driver 33 generates the signal line driving signal to the signal lines BL₀, BL₁, BL₂, and BL₃ in response to the signal line control signal. During the ON period of each scan line driving signal, the signal line driving signal drives the plurality of LEDs on each signal line to emit light. On the other hand, during the OFF period of each scan line driving signal, the signal line driving signal does not drive the plurality of LEDs on each signal line to emit light.

In the embodiments of the disclosure, the signal line driver 33 does not only provide the signal line driving signal, but also provides the discharging control signals DP₀, DP₁, DP₂, DP₃ and/or pre-charging control signals PP₀, PP₁, PP₂, PP₃ during the OFF period T_{DEAD} of the scan line driving signal. In this case, the signal line driver 33 is further defined as the signal line driver which is of capable eliminating the anomalous bright points. The signal line driver 33 comprises a driving circuit, a discharging circuit, and a charging circuit. In an embodiment, a driving circuit and a discharging circuit may share a same circuit path, and additional logic gates are used to achieve the circuit path share. In another embodiment, an additional discharging circuit having the same components as the driving circuit is used.

As shown by the circuit of FIG. 6, the scan line driver 32 provides the scan line driving signal SK₀, SK₁, SK₂, or SK₃ in response to the scan line control signal provided by the controller 31. The scan line driving signal SK₀, SK₁, SK₂, or SK₃ is used to control the opening or closing of the switch K₀, K₁, K₂, or K₃. One end of the switches K₀, K₁, K₂, and K₃ is connected to the power supply source VBB. The signal line driver 33 provides the signal line driving signals SF₀, SF₁, SF₂, or SF₃ in response to the signal line control signal provided by the controller 31. The signal line driving signals SF₀, SF₁, SF₂, or SF₃ is used to control the opening or closing of the switch F₀, F₁, F₂, or F₃. The current sources J₀, J₁, J₂, and J₃ in the signal line driver 33 provide current for driving the LEDs. More particularly, the switches F₀, F₁, F₂, and F₃ and the corresponding connected current sources J₀, J₁, J₂, and J₃ are used to form the driving circuits for driving the LEDs.

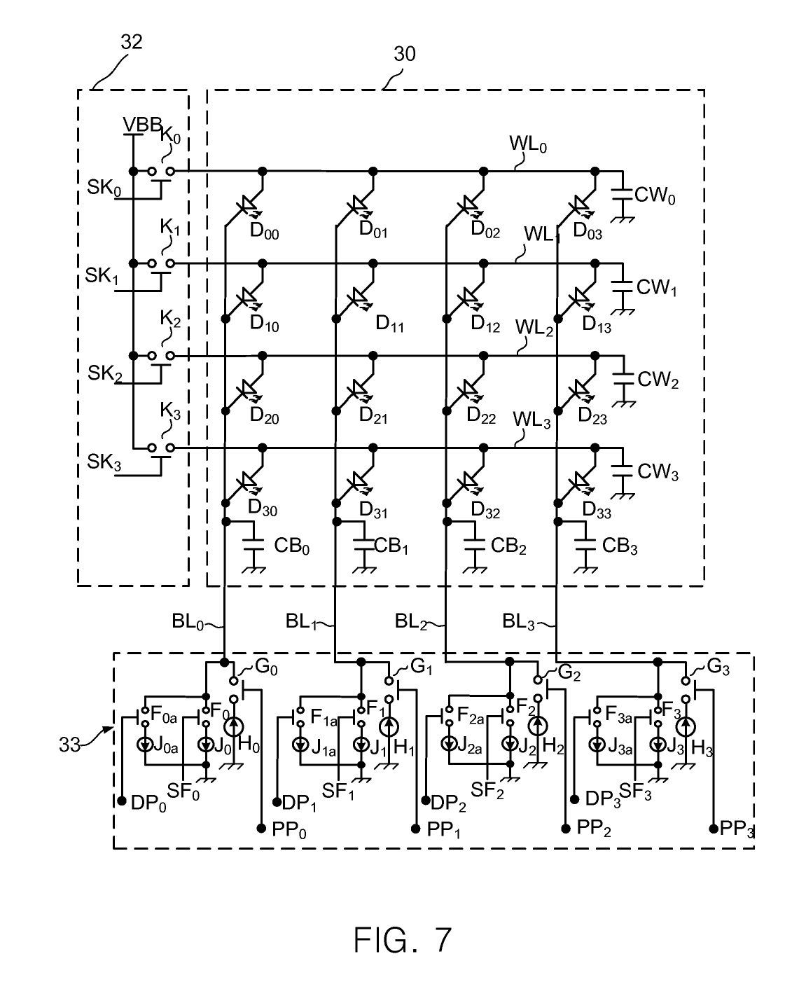

As described above, the signal line driver 33 further comprises a discharging circuit and a charging circuit. The parasitic capacitors CW₀, CW₁, CW₂, and CW₃ are discharged by the discharging circuit. The parasitic capacitors CB₀, CB₁, CB₂, and CB₃ are charged by the charging circuit. In an embodiment, the discharging circuit can share with the driving circuit, as shown in FIG. 6. Alternatively, an additional discharging circuit different from the driving circuit may be designed, as shown in FIG. 7.

The discharging circuit sharing with the driving circuit comprises not only the switches F₀, F₁, F₂, and F₃, but also the current sources J₀, J₁, J₂, and J₃ respectively connected to the switches F₀, F₁, F₂, and F₃. The logic gates L₀, L₁, L₂, and L₃ generates control signals for controlling the switches F₀, F₁, F₂, and F₃ according to the signal line driving signals and the discharging control signals. In other words, each switch F₀, F₁, F₂, or F₃ is controlled by the signal SA₀, SA₁, SA₂, or SA₃ outputted from the logic gates L₀, L₁, L₂, or L₃. In this embodiment, all the logic gates may be OR gates. The two inputs of the logic gates L₀, L₁, L₂, and L₃ are inputted with the discharging control signals DP₀, DP₁, DP₂, and DP₃ and the signal line driving signal SF₀, SF₁, SF₂, and SF₃ respectively. Therefore, if one of the signal line driving signal (SF₀, SF₁, SF₂, or SF₃) and the discharging control signal (DP₀, DP₁, DP₂, or DP₃) is at a high voltage level, the logic gate will output a signal at a high voltage level to conduct the switch (F₀, F₁, F₂, or F₃). More particularly, if the signal line driving signal SF₀, SF₁, SF₂, or SF₃ is at a high voltage level, the logic gate L₀, L₁, L₂, or L₃ will output a signal at a high logic level to conduct the switch F₀, F₁, F₂, or F₃. At this time, the driving circuit instead of the discharging circuit is formed. If the discharging control signal DP₀, DP₁, DP₂, or DP₃ is at a high voltage level, the logic gate L₀, L₁, L₂, or L₃ will output a signal at a high logic level to conduct the switch F₀, F₁, F₂, or F₃. At this time, the discharging circuit instead of the driving circuit is formed.

Also with reference to FIG. 6, the charging circuits comprise the switches G₀, G₁, G₂, and G₃, and the current sources H₀, H₁, H₂, and H₃. The switches G₀, G₁, G₂, and G₃ are controlled by the charging control signals PP₀, PP₁, PP₂, and PP₃ generated by the signal line driver 33. It should be note that, in the embodiment, the discharging circuit and the charging circuit are disposed in one figure. However, the disclosure is not limited this way. A single discharging or charging circuit may be implemented in one embodiment. Moreover, both the discharging circuit and the charging circuit may be disposed in one embodiment. A control signal may be used to determine whether to start the discharging circuit or the charging circuit.

In the embodiment of FIG. 7, an additional discharging circuit is used. That is, different from the embodiment shown in FIG. 6, the embodiment of FIG. 7 uses an additional discharging circuit to perform the discharge process, but in FIG. 6 the discharging circuit and the driving circuit share a same circuit path. In FIG. 7, the discharging circuit comprises the switches F₀ₐ, F₁ₐ, F₂ₐ, and F₃ₐ, and the current sources J₀ₐ, J₁ₐ, J₂ₐ, and J₃ₐ connected to the switches F₀ₐ, F₁ₐ, F₂ₐ, and F₃ₐ respectively. The discharging circuit has the same components as the driving circuit. In this embodiment, the switches F₀, F₁, F₂, and F₃ in the driving circuit are controlled by the signals SF₀, SF₁, SF₂, and SF₃. In addition, the driving circuit is connected in parallel with the discharging circuit. The switches F₀ₐ, F₁ₐ, F₂ₐ and F₃ₐ are controlled by the discharging control signals DP₀, DP₁, DP₂, and DP₃.

The detailed charging process and discharging process will be explained with reference to FIG. 8. Firstly, the image scanning process is described below. In each scanning period, only one scan line is drove. The SKₙ, SKₙ₊₁, SKₙ₊₂ . . . shows the scanning period for driving each scan line. For easy illustration, the following description will use n to represent each component. Each scanning period is divided into two parts, i.e., the ON period T_{ACTIVE} for turning on the LEDs and the OFF period T_{DEAD} for turning off the LEDs.

Furthermore, the ON period T_{ACTIVE} is divided into three parts which are a first predetermined time period T₅, a display time period T_{DISPLAY}, and a second predetermined time period T₇. For example, during the display time period T_{DISPLAY}, when the n+1th line of LEDs is displayed, the switch SKn+1 will be open. After the first predetermined time T₅, the switch Fn in the signal line driver 33 is conducted to drive the LED to emit light. The time period for emitting light is further defined as the display time period T_{DISPLAY}. After the display time period and then the second predetermined time T₇, all switches Kₙ will be closed to enter the OFF period T_{DEAD} because a new line of scan line, for example, n+2 th line, will be scanned. The first predetermined time period T₅ and the second predetermined time period T₇ may be zero or non-zero. The length of the above mentioned time periods can be controlled.

The OFF period T_{DEAD} is used for the discharging process and charging process of the parasitic capacitors. That is, the OFF period T_{DEAD} is used to eliminate the up-ghost and down-ghost. It should be noted that the embodiment comprises eliminating both up-ghost and down-ghost. However, the disclosure is not limited this way. For example, an embodiment can only eliminate the up-ghost or the down-ghost.

The following will explain the process for eliminating up-ghost.

When a scan line is switched to be the next line, for example, from the nth line to the n+1 th line. During the OFF period T_{DEAD}, after a first waiting time T₀ of the OFF period T_{DEAD}, the scan line driver outputs a discharging control signal. As a result, the logic gates L₀, L₁, L₂, and L₃ output the control signals SA₀, SA₁, SA₂, and SA₃ at a high voltage level to conduct one or more current switches Fn in the signal line driver for a first conduction time T₁. At this time, the electric charge on the parasitic capacitor CWₙ on the nth scan line WLₙ is discharged by a discharging path which is formed by the signal line and the opening switch Fn in the current driving device. The discharged current is equal to the current value of the current source Jn. This discharge process is different from the discharge process by LEDs as described in the prior art. In the discharge process, the voltage of the parasitic capacitor CWₙ on the nth scan line WLₙ decreases, and the forward bias voltage of the LED connected to the nth scan line WLₙ is smaller than the conduction specified voltage of the LED. Thus, the up-ghost is eliminated.

The electric charge on the parasitic capacitor CWₙ can be discharged by the original discharge circuit in the signal line driver, as shown in FIG. 6. Alternatively, the electric charge on the parasitic capacitor CWₙ can be discharged by the additional discharging circuit, as shown in FIG. 7.

It should be noted that, the first waiting time T₀ before generating the discharging control signal can be zero or non-zero. The length of the first waiting time can be controlled. In addition, the first conduction time T₁ for the current switch Fn in the signal line driver can be zero or non-zero. The length of the first conduction time T₁ is also can be controlled. Furthermore, the current of the current source Jₙ for the discharging process can be controlled.

The following will explain the process for eliminating the down-ghost.

After the first conduction time T₁ and the second waiting time T2, one or more switches Gₙ in the signal line driver are in conduction for a second conduction time T₃. At this time, because of the conduction of the switch Gₙ, the parasitic capacitor CBₙ on the vertical signal line BLₙ is charged to be at a high voltage level. The forward bias voltage of the LED connected to the n+1 th line of scan line WLₙ₊₁ is smaller than the conduction specified voltage of the LED. Thus, the down-ghost can be eliminated. Then, after the third waiting time T4, the display period for the next scan line (n+1)th line) will begin. The driving switch SKₙ₊₁ for the (n+1)th scan line will be open for the operation of the next scan line.

It should be noted that, the second waiting time T₂ can be zero or non-zero. The second conduction time T₃ can be zero or non-zero. The third waiting time T₄ after the pre-charging process can be zero or non-zero. Furthermore, the second predetermined time T₇ after displaying the LED image can be zero or non-zero. The length of the time mentioned above can be controlled.

During a period (T₆) which is after the first conduction time T₁ (i.e., after generating the discharging control signal) and before the end of the T_{DEAD}, the state of the switch SKn+1 of the scan line does not influence eliminating the down-ghost. Thus, in the period T₆ of the OFF period T_{DEAD}, the plurality of scan lines can be drove or not to be drove. The time T6 can be zero or non-zero, and the length of the time can be controlled.

Based on the above, the signal line driver provides a discharging control signal or a charging control signal during the OFF period of the scan line driving signal. As a result, the signal line driver provides a discharging path in response to the discharging control signal or provides a charging path in response to the charging control signal. Furthermore, the parasitic capacitors on the plurality of scan lines can be discharged by the discharging path and the parasitic capacitors on the plurality of signal lines can be charged by the charging path.

The present disclosure provides a driving system for a dot-matrix light-emitting diode (LED) display which is capable of eliminating anomalous bright points (or called as up-ghost and down-ghost). The driving system configures a discharging circuit and/or a charging circuit in the signal line driving system. The control signals for controlling the discharging circuit and/or the charging circuit are generated during the time period when the LED does not emit light. As a result, the parasitic capacitors on the scan lines or the signal lines can be discharged or charged by the signal lines but not by LEDs. Therefore, the anomalous bright points can be eliminated.

Based on the embodiment disclosed as above, no additional circuits are needed to eliminate the up-ghost and down-ghost. In this case, the circuit cost can be reduced. Furthermore, LED does not need to carry the reverse bias voltage which is beyond the specified standard, and thus the service life of the LED is not impacted.

Note that the specifications relating to the above embodiments should be construed as exemplary rather than as limitative of the present invention, with many variations and modifications being readily attainable by a person skilled in the art without departing from the spirit or scope thereof as defined by the appended claims and their legal equivalents.

What is claimed is:

1. A driving system for a dot-matrix light-emitting diode (LED) display device, the driving system being used to drive a display panel comprising a plurality of LEDs, each LED being disposed at intersections of a plurality of scan lines and a plurality of signal lines, the driving system comprising:
a controller for providing a scan line control signal and a signal line control signal;
a scan line driver for generating a scan line driving signal to drive the plurality of the scan lines in response to the scan line control signal, the scan line driving signal includes an ON period and a OFF period; and
a signal line driver for generating a signal line driving signal in response to the signal line control signal, the signal line driving signal driving the plurality of LEDs to emit light during the ON period, wherein the signal line driver generating a discharging control signal during the OFF period so that the signal line driver and the plurality of signal lines form a plurality of discharging paths through which parasitic capacitors on the plurality of scan lines are discharged.

2. The driving system according to claim 1, wherein the discharging control signal is provided by the signal line driver during a first waiting time after the beginning of the OFF period.

3. The driving system according to claim 2, wherein the first waiting time is zero or non-zero.

4. The driving system according to claim 1, wherein each of the plurality of the discharging paths is composed of a switch and a current source connected to the switch.

5. The driving system according to claim 4, wherein the switch is controlled by a logic gate, and the logic gate generating a control signal for controlling the switch according to the signal line driving signal and the discharging control signal.

6. The driving system according to claim 4, wherein the discharging control signal controls the switch to turn on for a first conduction time.

7. The driving system according to claim 6, wherein the first conduction time is zero or non-zero.

8. The driving system according to claim 1, wherein the signal line driver further generates a charging control signal after a second waiting time, the second waiting time being after generating the discharging control signal, so that the signal line driver and the plurality of signal lines form a plurality of charging paths through which parasitic capacitors of the plurality of the signal lines are charged.

9. The driving system according to claim 8, wherein the second waiting time is zero or non-zero.

10. The driving system according to claim 8, wherein the charging path is composed of a switch and a current source connected to the switch.

11. The driving system according to claim 10, wherein the charging control signal controls a second conduction time for conducting the switch.

12. The driving system according to claim 11, wherein the second conduction time is zero or non-zero.

13. The driving system according to claim 8, wherein a time interval between generating the charging control signal and the ON period is a third waiting time.

14. The driving system according to claim 13, wherein the third waiting time is zero or non-zero.

15. The driving system according to claim 1, wherein the ON period comprises a first predetermined time, a display time after the first predetermined time, and a second predetermined time after the display time.

16. The driving system according to claim 15, wherein the first predetermined time is zero or non-zero, and the second predetermined time is zero or non-zero.

17. The driving system according to claim 1, wherein the plurality of scan lines are drove or not to be drove during a period after generating the discharging control signal and before end of the OFF period.

18. The driving system according to claim 17, wherein the period is zero or non-zero.

19. A driving method for a dot-matrix light-emitting diode (LED) display device, the driving method being used to drive a display panel comprising a plurality of LEDs, each LED being disposed at intersections of a plurality of scan lines and a plurality of signal lines, the driving method comprising:
providing a scan line control signal and a signal line control signal;
generating a scan line driving signal in response to the scan line control signal, the scan line driving signal being divided into an ON period and a OFF period; and
generating a signal line driving signal in response to the signal line control signal, the signal line driving signal driving the plurality of LEDs to emit light during the ON period, wherein the plurality of LEDs do not emit light during the OFF period; and
generating a discharging control signal during the OFF period so that the plurality of signal lines form a plurality of discharging paths through which parasitic capacitors on the plurality of scan lines are discharged.

20. The driving method according to claim 19, wherein the discharging control signal is provided after a first waiting time, the first waiting time being after beginning of the OFF period.

21. The driving method according to claim 20, wherein the first waiting time is zero or non-zero.

22. The driving method according to claim 19, wherein the discharging control signal controls the discharging path being conducting for a first conduction time.

23. The driving method according to claim 22, wherein the first conduction time is zero or non-zero.

24. The driving method according to claim 19, further comprising generating a charging control signal after a second waiting time, the second waiting time being after generating the discharging control signal, and providing a charging path in response to the charging control signal so that the plurality of signal lines form a plurality of charging paths through which parasitic capacitors on the plurality of signal lines are charged.

25. The driving method according to claim 24, wherein the second waiting time is zero or non-zero.

26. The driving method according to claim 24, wherein a time interval between generating the charging control signal and the ON period is a third waiting time.

27. The driving method according to claim 26, wherein the third waiting time is zero or non-zero.

28. The driving method according to claim 24, wherein the charging control signal controls the charging path being conducting for a second conduction time.

29. The driving method according to claim 28, wherein the second conduction time is zero or non-zero.

30. The driving method according to claim 19, wherein the ON period comprises a first predetermined time, a display time after the first predetermined time, and a second predetermined time after the display time.

31. The driving method according to claim 30, wherein the plurality of scan lines are drove or not to be drove during a period after generating the discharging control signal and before end of the OFF period.

32. The driving method according to claim 31, wherein the period is zero or non-zero.

33. The driving method according to claim 30, wherein the first predetermined time is zero or non-zero, and the second predetermined time is zero or non-zero.
